(19) United States
(12) Patent Application Publication
(10) Pub. No.: US 2023/0287867 A1
(43) Pub. Date: Sep. 14, 2023

(54) VIMPROVED HORIZONTAL WIND TURBINE

(71) Applicants: Nikolai Nikolayevich TERESHCHUK, Norilsk (RU); Valerii Yurevich VOROBEV, Krasnoyarsk (RU)

(72) Inventor: Valerii Yurevich VOROBEV, Krasnoyarsk (RU)

(21) Appl. No.: 18/019,253

(22) PCT Filed: Aug. 2, 2021
(86) PCT No.: PCT/IB2021/057052

§ 371 Date: Feb. 2, 2023

Related U.S. Application Data
(60) Provisional application No. 63/060,144, filed on Aug. 3, 2020.

(51) Int. Cl. F03D 7/02; F03D 1/06; F03D 1/02; F03D 9/25

(52) U.S. Cl. CPC F03D 7/0236; F03D 1/025; F03D 1/0625; F03D 9/25; F05B 2240/13; F05B 2240/2022

(57) ABSTRACT

The present invention relates to wind energy and can be used to harvest and convert kinetic wind energy into electricity with higher efficiency.

Wind turbine that improves the efficiency of converting wind energy into electrical energy by implementing mechanical design features which harness the entrainment effect by using main rotor blades that are mounted at some distance from the center axis of rotation to allow airflow to pass through its center and to be accelerated by any means (jet fan for example), thus creating higher velocity lower pressure air stream (according to Bernoulli’s law) behind the wind turbine increasing airflow (entrainment effect) through the main rotor blades.

The invention as claimed is a lift-based horizontal-axis wind turbine, the design of which provides higher performance efficiency by extracting more energy from the airflow and at better coefficient of performance and converting it into electrical energy, compared to conventional lift-based horizontal-axis wind turbines of the same turbine rotor diameter.

### FIELD OF INVENTION

The present invention relates to wind energy and can be used to harvest and convert kinetic wind energy into electricity. Groups: F03D, F03D 1/00 (others might be applicable).

### BACKGROUND ART

There are many different types of wind turbines based on different energy extraction concepts, but in general divided into two groups: lift-based and drag-based. Horizontal wind turbine (horizontal-axis wind turbine (HAWT)) is the most common lift-based topology. It captures the kinetic energy of the wind by creating lift on its blades and transforming rotational mechanical energy into electrical energy.

Conventional horizontal wind turbines comprise a turbine rotor with blades mounted upwind perpendicularly to the turbine rotor shaft which is connected through a gear box (multiplier - a component used for converting low-speed incoming rotation to high-speed rotation suitable for generating electricity) to an electrical generator, a rotor yaw mechanism for rotating the rotor according to the wind direction and a tower on the top of which all the components are mounted. The center of the turbine rotor is commonly used for a nacelle which serves as a housing for the multiplier, generator, generator rotor shaft and turbine rotor shaft and connects the tower and the rotor. The presence of the nacelle in the center of the rotor doesn’t contribute much to the performance of the wind turbine since the blade rotational velocity in the center is low.

### BRIEF SUMMARY OF THE INVENTION

Present wind turbine improves the efficiency of converting kinetic wind energy into electrical energy by implementing mechanical design features which harness the entrainment effect by using “hollow center” part and blades mounted at a distance from the center axis of rotation (rotor shaft) to allow airflow to pass through at undisrupted (original) or accelerated speed (by means of jet fan or using other methods) thus creating higher velocity air stream behind the wind turbine. Moreover, efficiency could be improved further, by using a unique blade configuration (angled blades to the plane of rotation).

The Summary of the invention is provided to introduce the idea of the invention in a simplified form, which is further disclosed below in the description of the invention. The Summary of the invention is neither intended to identify the essential features of the claimed object of the invention, nor is it intended to be used for the purpose of limiting the scope of the invention.

### TECHNICAL PROBLEM

Since the aerodynamic characteristics are obviously a very important aspect of wind turbines performance efficiency, there is always a goal to improve them.

Furthermore, the design of lift-based wind turbines should be directed to complete use of rotational speed to create lift, but not to block the incoming airflow. Thus, the object of the present invention is to create a lift-based horizontal-axis wind turbine, the design of which will provide higher performance efficiency by extracting more kinetic energy from the airflow and at better coefficient of performance and converting it into electrical energy, compared to conventional lift-based horizontal-axis wind turbines of the same turbine rotor diameter.

### SOLUTION TO PROBLEM

The above problem is solved by providing a wind turbine comprising of a turbine rotor (a set of blades) with a working area (that can create lift) at the outer radius of the rotor (anywhere from 0.75R to 1 R), having the horizontal axis of rotation and mounted on a turbine rotor shaft by means of supporting rods, which harness the entrainment effect by using “hollow center” part and blades mounted at a distance from the center axis of rotation (rotor shaft) to allow airflow to pass through at undisrupted (original) or accelerated speed (by means of jet fan or using other methods) thus creating higher velocity air stream behind the wind turbine.

The “hollow center” part can act “as is” or be diffuser augmented or used with mechanically or electrically driven fan (or jet fan) to create higher velocity air stream (airflow) from the power captured by the outer wind turbine rotor blades.

Turbine rotor blades are connected to the turbine rotor shaft by any means (supporting rods or spokes with a rim base, as a few examples) and positioned at the outer edge of the “hollow center” part. They (blades) can overlap it or sit away (not in a single plane of rotation) on a rotor shaft from the “hollow center” part. The said blades could also be straight or angled up or downwind from the plane of rotation to further increase the performance of said wind turbine.

Electrical generator is said wind turbine is configured to be driven by the wind turbine rotor directly (at the speed of wind turbine rotor shaft) or through the use of multiplier (creating higher rotational speed), with mechanical or electromagnetic connection which could be fixed or use freewheel or other means of connection to the wind turbine rotor.

### ADVANTAGEOUS EFFECTS OF INVENTION

The presented wind turbine is characterized in that it comprises a “hollow center” part which allows the air to flow through the center of the rotating blades undisrupted at original wind speed or to accelerate to a higher velocity than the original wind speed behind the turbine rotor blades (wake).

Aforesaid makes “an entrainment effect” - faster moving airflow creates a lower pressure area behind the turbine rotor (according to Bernoulli law), speeds up the airflow coming through the turbine rotor and gets turbulent air away faster.

Since lift depends on the surface area over which the air flows, positioning the turbine rotor blades at an angle to the plane of rotation (angled downwind or upwind), in turn, makes it possible to use longer blades retaining the same outer turbine rotor diameter and, thus, to create relatively higher lift.

Consequently, by decreasing the blocking of the incoming airflow and increasing lift compared to the conventional lift-based horizontal-axis wind turbines, higher performance efficiency could be achieved.

### BRIEF DESCRIPTION OF DRAWINGS

The invention is explained in more detail by means of the figures showing preferred embodiments of the wind turbine:

FIG. 1 is a schematic view of one of the preferred embodiments of the claimed wind turbine in a longitudinal section;

FIG. 2 is a schematic view of another preferred embodiment of the claimed wind turbine in a longitudinal section;

FIG. 3 is a schematic comparative view of one of the preferred embodiments of the claimed wind turbine in a longitudinal section and the conventional wind turbine;

FIG. 4 is a schematic comparative view of the conventional and the claimed wind turbine blade rotational velocity;

FIG. 5 is a schematic view of another preferred embodiment of the claimed wind turbine;

FIG. 6 is a schematic view of another preferred embodiment of the claimed wind turbine;

FIG. 7 is a partly sectional view of one of the preferred embodiments of the claimed wind turbine. The invention is explained in more detail by means of the figures showing preferred embodiments of the wind turbine:

### DESCRIPTION OF EMBODIMENTS

It should be clear that the diffuser comprises an inlet and an outlet, wherein the inlet has smaller diameter than the outlet. It also should be clear that the diffuser mounted coaxially with the turbine rotor shaft has its inlet facing upwind.

It should be clear that the term “angled” describes the direction in which the blades are angled to the plane of rotation and to the incoming airflow direction, wherein the incoming airflow is facing the front of the construction of the wind turbine.

It should be clear that the term “front” of the wind turbine is used for the side of the construction facing the incoming airflow.

In the preferred embodiment of the invention, the turbine rotor blades are set at fixed or adjustable angle. For the purpose of angle adjustment turbine rotor blades could be mounted on top of the supporting rods by means of joints. Adjustment of the angle helps to conserve the coefficient of lift at its optimal level.

In the preferred embodiment of the invention, the turbine comprises a multiplier and the generator is configured to be driven by the turbine rotor via the turbine rotor shaft, the multiplier and a generator rotor shaft.

It should be clear that the term “multiplier” is used for the “multiplying gear”, which turns the slow rotation of the wind turbine rotor into a quicker rotation of the electrical generator rotor that is more suitable for effective electricity generation. In the preferred embodiment of the invention, the multiplier is either electrical or mechanical. Nevertheless, it should be clear that there could be embodiments of the invention, wherein a different type of electrical generator is used, for example, the one suited to slower rotational speed input and, thus, driven directly from the turbine rotor shaft, with no multiplier in between.

In one of the preferred embodiment of the invention, the turbine comprises a mechanical air fan (set of blades to speed up an air stream) with a generator inside of it, mounted inside the “hollow center” part, but some distance away from the plane of rotation of the wind turbine rotor blades, although sitting on the same shaft, but connected via freewheel to allow to harness the rotational energy of the wind turbine when there is one, but spin freely (keeping momentum) otherwise.

A (jet) fan helps to increase the “entrainment effect” by creating a higher air flow velocity stream and, thus, creating a lower pressure area behind the wind turbine rotor and hence speeding up the airflow through the wind turbine rotor.

The supporting rods (or spokes), in turn, could also be used to create pattern in outgoing high velocity stream of airflow.

It should be clear that there could be embodiments of the invention, wherein the jet fan is driven via a separate shaft, not the generator rotor shaft or by using different configuration of fan rotor blades inside the inner diameter (the “hollow center” part mentioned above).

In one of preferred embodiments of the invention, the generator comprises a generator built into the blade supporting rim (could also act as a diffuser body).

In another preferred embodiment, a different type of electrical generator comprising a separate housing is used.

It should be clear that depending on the particular embodiment all the components (the turbine rotor, multiplier, generator, diffuser, turbine rotor shaft, generator rotor shaft and fan) could be configured differently and could even be separated into two separate planes, but still working together in order to achieve a higher efficiency.

It should be clear that depending on the particular embodiment all the components (the turbine rotor, multiplier, generator, diffuser, turbine rotor shaft, generator rotor shaft and fan) could be installed on the top of the tower, nevertheless there could be embodiments, wherein, for example, the generator and the multiplier are separated from other components, mounted at the bottom of the tower and driven from the wind turbine rotor via additional gears and shafts.

In one of the preferred embodiment of the invention, the turbine comprises a nacelle mounted inside the diffuser with a clearance and serving as a housing at least for the generator rotor shaft and the turbine rotor shaft. It should be clear that depending on the particular embodiment the multiplier and the generator could also be mounted inside the nacelle.

Aspects of the present invention are further disclosed with reference to the figures that are non-limiting examples of the embodiments of the present invention.

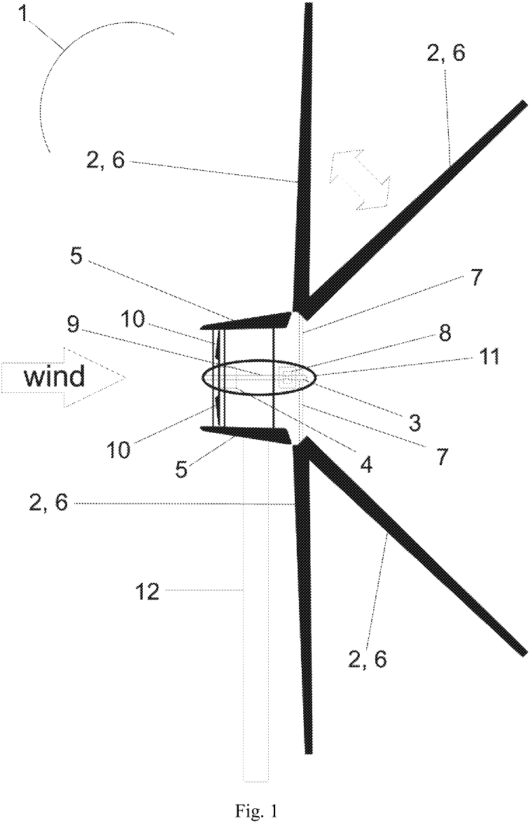

FIG. 1 shows one of the preferred embodiments of the claimed wind turbine (1) in a longitudinal section. As it can be seen in the figure, the claimed wind turbine (1) comprises a turbine (1) rotor (2), having the horizontal axis of rotation and mounted on a turbine (1) rotor (2) shaft (3), an electrical generator (4), a “hollow center” part (5) mounted coaxially with the turbine (1) rotor (2) shaft (3), said turbine (1) rotor (2) comprises a set of blades (6) and supporting rods (7), said blades (6) are mounted on the turbine (1) rotor (2) shaft (3) by means of supporting rods (7), positioned at the outer edge of the back of the diffuser (5) and angled downwind. The turbine (1) also comprisesa multiplier (8) and the generator (4) is configured to be driven by the turbine (1) rotor (2) via the turbine (1) rotor (2) shaft (3), the multiplier (8) and a generator (4) rotor shaft (9). The turbine 1 also comprises a jet fan (10) mounted inside the diffuser (5) and configured to be driven by the turbine (1) rotor (2) via the turbine (1) rotor (2) shaft (3), the multiplier (8) and the generator 4 rotor shaft (9). A generator (4) stator (not shown) is built into the diffuser (5) and a generator (4) rotor (not shown) is built into the jet fan (10). The turbine 1 comprises a nacelle (11) mounted inside the diffuser (5) with a clearance and serving as a housing for the generator (4) rotor shaft (9), the turbine (1) rotor (2) shaft (3) and the multiplier (8). The turbine (1) comprises a tower (12), on the top of which all the components are mounted. The blades (6) are set at an adjustable angle, and an arrow shows the direction of angle adjustment. Thus, it should be clear that the figure shows two positions of two blades (6).

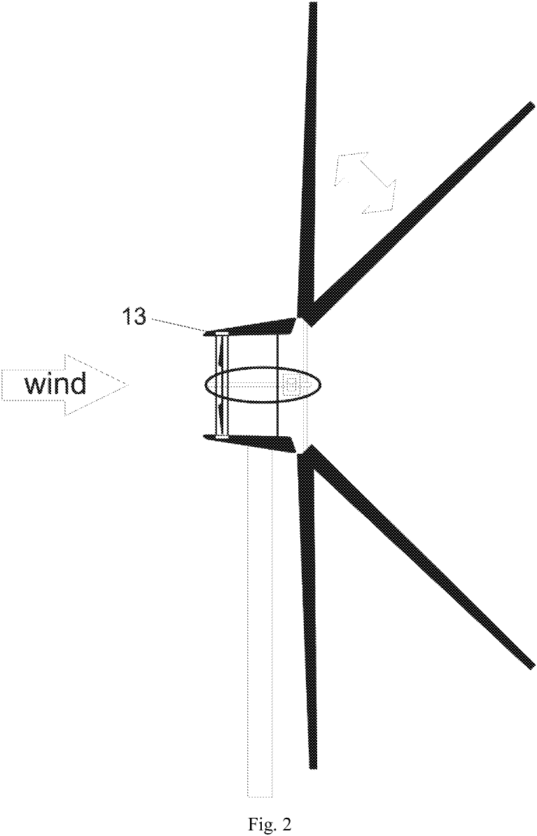

FIG. 2 shows another preferred embodiment of the claimed wind turbine (1) in a longitudinal section, which differs from the embodiment shown in FIG. 1 in a type of generator used. In this particular embodiment, the direct drive generator (13) is embodied into the diffuser (5) housing and not in the nacelle (11).

It is important to note that the tip-speed ratio (TSR) usually means a higher rotational velocity of the tip of the blade than the speed of the incoming wind, hence the rotational speed is contributing significantly to the overall performance of the wind turbine more so than just the direct wind pressure on the blades. The velocity of the incoming air and the rotational velocity create “apparent wind” with an angle of attack that varies from the center of rotation to the tip of the blade.

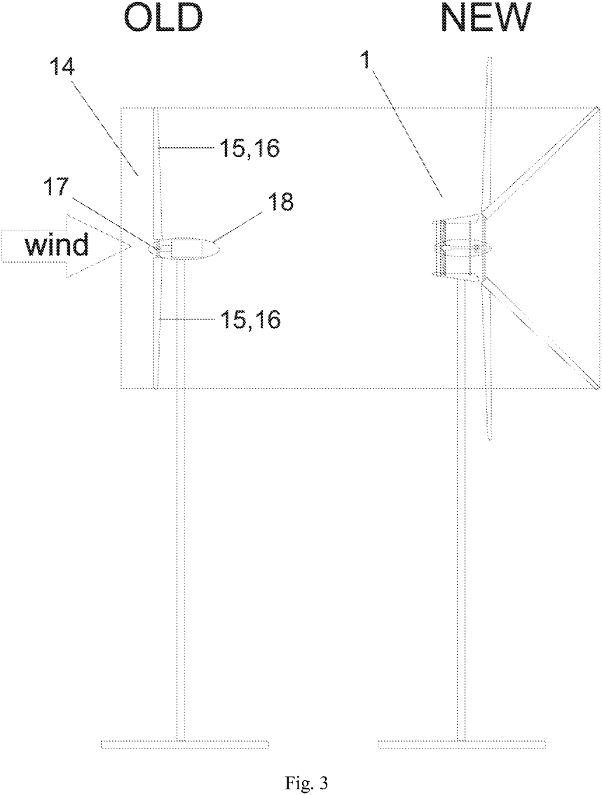

FIG. 3 shows a comparative view of one of the preferred embodiments of the claimed wind turbine (1) and the conventional wind turbine (14) in a longitudinal section. The conventional wind turbine (14) comprises a wind turbine (14) rotor (15), wherein the blades 16 are, in general, perpendicular to the wind turbine (14) rotor (15) shaft (17). As can be seen, in the conventional wind turbine (14) the center is used for the nacelle (18), since the blade (16) rotational velocity here is low and it doesn’t contribute much to its performance. In comparison to the conventional wind turbine (14) of the same diameter, the presented wind turbine (1) has blades (6) mounted on the turbine (1) rotor (2) shaft (3) by means of supporting rods (7), positioned at the outer edge of the back of the diffuser (5) at greater distance from the center and angled downwind. As can be seen, both wind turbines (1) and (14) have the same rotor diameter, while having different length of blades, the conventional wind turbine (14) blades (16) length is smaller than the claimed wind turbine (1) blades (6) length, which is done by positioning the blades (6) at an angle to the plane of rotation (angled downwind in this example). Because the tip-speed ratio (TSR) remains the same, it allows for a larger area of the blade to move faster through the air and makes it possible to use longer blades, while maintaining the same revolutions per minute (RPM). Adjustment of the angle of attack, in turn, conserves the coefficient of lift at its optimal level.

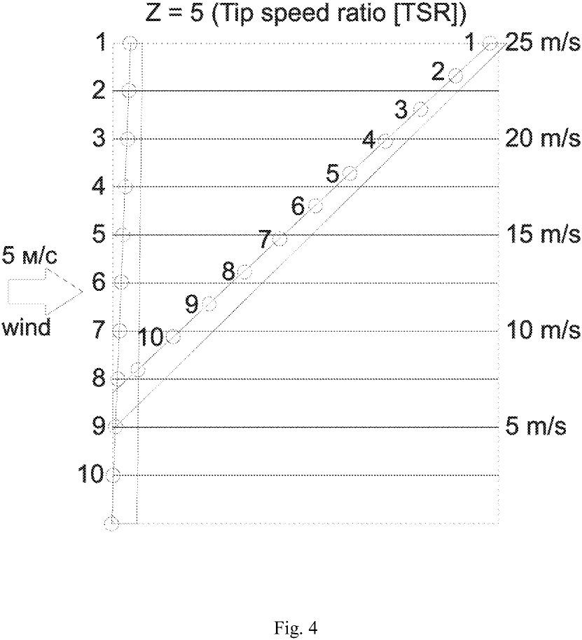

FIG. 4 shows a comparative view of the conventional wind turbine and the claimed wind turbine blade rotational velocity for ten separate points. One blade is mounted conventionally at the hub and the other blade (presented) is mounted on the supporting rod (not shown) and angled back. By calculation of the lift for ten separate points the considerable improvements in lift can be seen. Moreover, since lift 7 depends on the surface area over which the air flows, longer blades could be used, while keeping the same outer rotor diameter, as it can be seen in the figure.

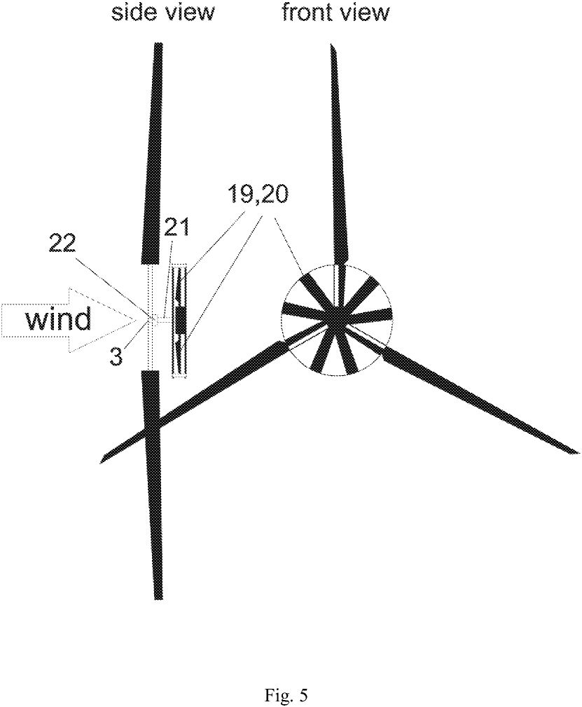

FIG. 5 shows another preferred embodiment, as tested on our prototype, of the claimed wind turbine (1) in a longitudinal section, which differs from the embodiment shown in FIG. 1 in a configuration. In this particular embodiment, the generator (13) is embodied into second rotor (19) with blades (20) that acts as a fan (10) (jet fan) and rotor (2) shaft (3) is connected to rotor (19) shaft (21) via freewheel (22).

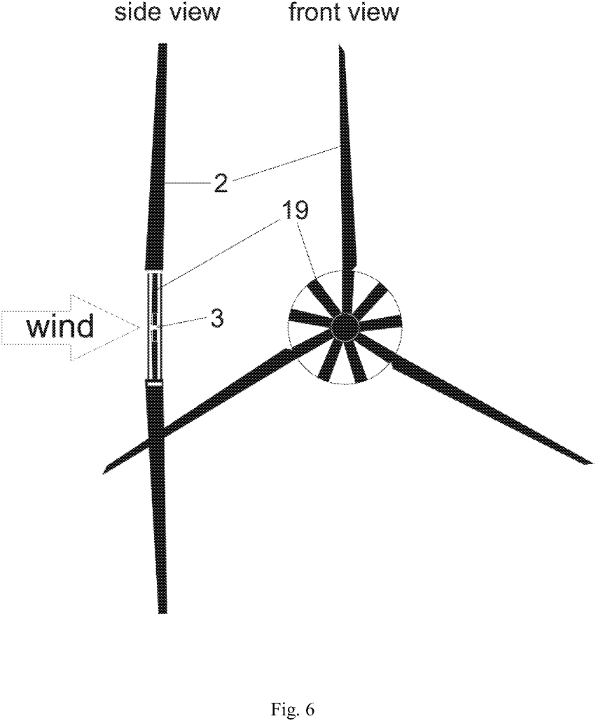

FIG. 6 shows another preferred embodiment, of the claimed wind turbine (1) in a longitudinal section, which differs from the embodiment shown in FIG. 1 in a simplified configuration. In this particular embodiment, the generator (13) is placed in between rotor (2) and second rotor (19) with blades (20) that acts as a fan (10) (jet fan) and both rotors (2, 19) use the same rotor (2) shaft (3).

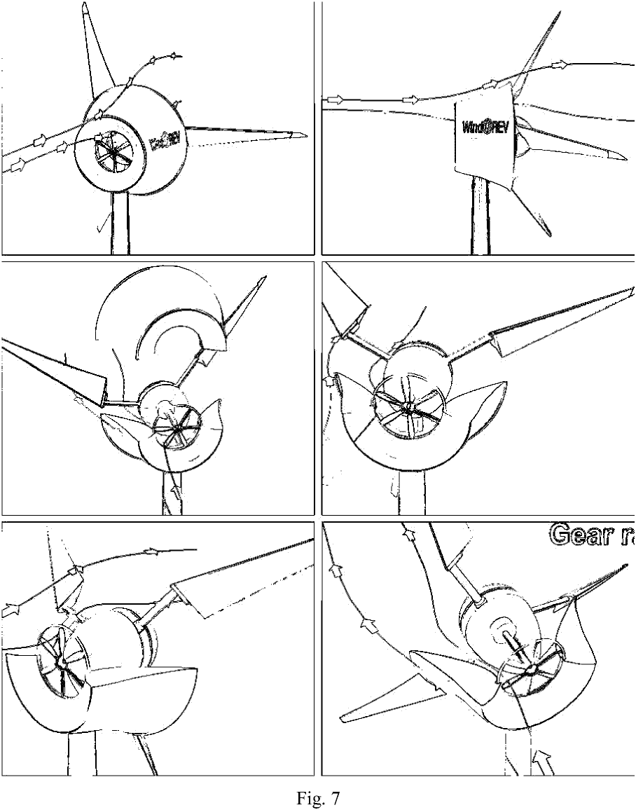

FIG. 7 shows different views of one of the preferred embodiments of the claimed wind turbine. As can b e seen, the diffuser (5) separates the airflow: the airflow (23) comes through the turbine (1) rotor (2) and the airflow (24) comes through the diffuser (5) and is sped up by the jet fan (10).

In a simplified presentation, the wind turbine 1 as claimed is operated as follows. The incoming airflow is divided into two parts via the “hollow center” part (5): the airflow (24) comes through the center (5) and is accelerated to the higher velocity than the original wind speed behind the rotor (2) blades (6), creating a lower pressure area behind the turbine (1) rotor (2) and thus speeding up another airflow (23) that comes through the turbine (1) rotor (2) creating lift on its blades (6). The turbine (1) rotor (2) rotates the turbine (1) rotor (2) shaft (3), which drives the electrical generator (4) or (13) through the multiplier (8) (depending on the embodiment) and the generator (4) or (13) rotor shaft (9). Depending on the embodiment of the invention, the angle of the turbine (1) rotor (2) blades (6) inclination is adjusted during the operation of the turbine (1), thus changing the angle of attack and conserving the coefficient of lift at its optimal level.

Thus, the invention as claimed is a lift-based horizontal-axis wind turbine, the said configuration of which provides higher performance efficiency by extracting more kinetic energy from the airflow and at better coefficient of performance and converting it into electrical energy, compared to conventional lift-based horizontal-axis wind turbines of the same turbine rotor diameter.

It should be taken into consideration that the wind turbine according to the present invention is not limited to the specific features described above. On the contrary, the specific features described above are disclosed as examples of embodiments of the present invention, and other equivalent features may be covered by the scope of the present invention.

1. A wind turbine, having design features that increase efficiency, comprising:
a main turbine rotor, comprises a set of blades set at any angle, fixed or adjustable, to the plane of rotation, having fixed or adjustable angle of attack of the blades and positioned at a distance from the center of rotation anywhere of 0.25R to 1R range of the total main rotor radius, connected to a turbine rotor shaft by supporting rods or any other mechanical means of holding the blades away from the turbine rotor shaft, having the horizontal axis of rotation;
a center section that can cover up to 0.75R of the total main rotor radius with minimum obstruction to the incoming wind flow;
a fan with any number of propelling blades or any other device either electrical or mechanical mounted in the above mentioned center section coaxially with the main turbine rotor shaft in the same or different plane of rotation configured to be driven by the main turbine rotor directly or main wind turbine rotor shaft directly or via a multiplier or a gearbox or a freewheel, accelerating incoming airflow to a higher speed air stream creating lower pressure area behind the wind turbine, that will positively effect airflow through the main rotor blades;
an electrical generator mounted coaxially with the main turbine rotor shaft in the same or different plane of rotation configured to be driven by the main turbine rotor directly or main wind turbine rotor shaft directly or via a multiplier or a gearbox or a freewheel.

2. The turbine of claim 1, wherein the fan or any other device that is accelerating incoming airflow to a higher speed air stream is mounted inside a diffuser or a shell or a rim that occupies the above mentioned center section and separates airflow and can further improve the performance of said wind turbine.

3. The turbine of claim 2, wherein a generator is built into diffuser body or the main rotor supporting rim or fan rim and allows to generate electricity at lower rotational speed of the main rotor.

4. A method of increasing wind turbine efficiency by using main rotor blades positioned at a distance from the center of rotation covering any radius of 0.25R-1R range of the main wind turbine rotor, to allow for incoming airflow to be accelerated by any means through the center of said wind turbine, where its center is set anywhere of 0R-0.75R range of main wind turbine rotor radius, creating higher velocity air stream that harnesses the entrainment effect by creating lower pressure area behind the wind turbine that in turn increases airflow through the main wind turbine rotor blades.

5. Method in claim 4, wherein the blades are angled to the plane of rotation, swept downwind or upwind, thus allowing for longer blades to be used in the same swept area to harness more energy, as opposed to conventional straight blades that are perpendicular to the axis of rotation and connected directly to the rotor shaft.
